(19) United States
(12) Patent Application Publication
(10) Pub. No.: US 2012/0260116 A1
(43) Pub. Date: Oct. 11, 2012

(54) EXTERNAL POWER-SAVING USB MASS STORAGE DEVICE AND POWER-SAVING METHOD THEREOF

(76) Inventors: Szu-Ming CHEN, Hsinchu (TW); Cheng-Fang Liu, Jhubei City (TW)

(21) Appl. No.: 13/084,240

(22) Filed: Apr. 11, 2011

(51) Int. Cl. G06F 1/32

(52) U.S. Cl. 713/324

(57) ABSTRACT

An external power-saving USB mass storage device has a USB interface, a USB controller, an interface unit, a device controller and a memory unit. The USB controller has a sleep mode determination process embedded therein for predicting when a USB host plugged in by the USB mass storage device will not access the memory unit of the USB mass storage device for a prolonged time, and activates a sleep mode of the device controller through the interface unit so as to instruct the device controller and the memory unit to enter a power-down state for power-saving purpose.

### BACKGROUND OF THE INVENTION

1. Field of the Invention

The present invention relates to an external USB (Universal Serial Bus) mass storage device, and more particularly to an external USB mass storage device capable of automatically entering a sleep mode for power-saving purpose.

2. Description of the Related Art

External USB mass storage devices are portable and applicable to carry data. Such a USB mass storage device is usually operated in collaboration with a USB host, such as a notebook computer, capable of accessing the USB external mass storage device. The external USB mass storage device has a USB interface, and a bus terminal of the USB interface is plugged into the USB host. The USB host can output host commands to the external USB mass storage device and further access data stored in the external mass storage device. With reference to FIG. 6, a conventional external USB mass storage device 60 has a USB interface 61, a USB controller 62, an interface unit 63, a device controller 64 and a memory unit 65. The USB controller 62 is electrically connected with the USB interface 61 and the interface unit 63, is electrically connected with the external USB host 70 through the USB interface 61, and is electrically connected with the device controller 64 through the interface unit 63. The device controller 64 is electrically connected with the memory unit 63.

When the external USB mass storage device 60 receives a host command outputted from the external USB host 70, the USB controller 62 processes the host command to determine if the host command contains an internal device instruction. If positive, the USB controller 62 instructs the device controller 64 to access the memory unit 65 through the interface unit 63. If negative, the USB controller 62 processes the host command and then directly responds to the USB host 70.

As a regular USB host periodically checks the status of connected USB devices, it sends out a host command containing polling instructions to determine if the external USB mass storage device is in an accessible state or in a disconnected state. When receiving the host command and determining that the host command contains nothing but polling instruction instead of internal device instruction, the USB controller 62 directly responds to the external USB host 70, and the interface unit 63, and the device controller 64 and the memory unit 65 are disabled. Although not enabled, the interface unit 63 stays in an active state and the device controller 64 stays in a wake-up state so as to be ready to access the memory unit 65 directly through the interface unit 63 and the device controller 64 whenever the USB controller 62 receives an internal device instruction.

Instead of frequently accessing data from the memory unit through the USB host, users usually operate the external USB mass storage device 60 by simply setting up a path for data access, issuing an access command and waiting for the completion of the data access after plugging the USB storage mass storage device 60 in the USB host. Hence, the actual time for the USB host to access data of the external USB mass storage device is considerably short. The USB controller 62, the interface unit 63 and the device controller 64 of the external USB mass storage device need to stay in a standby state to respond to host commands sent from the USB host in preparation for irregularly scheduled access from the USB host. However, such standby state consumes more power.

Even though the USB 1.1, 2.0 and 3.0 USB controllers are built in with a power-down or “suspend” mode, it is only the USB controller 62 being controllable to enter the suspend mode while the interface unit 63 and the device controller 64 always stay in a standby mode. Accordingly, the external USB mass storage device having the USB 1.1, 2.0 or 3.0 USB controller fails to significantly lower power consumption after a prolonged operation.

### SUMMARY OF THE INVENTION

A first objective of the present invention is to provide an external power-saving USB mass storage device capable of automatically entering a sleep mode for power-saving purpose.

To achieve the foregoing objective, the external power-saving USB mass storage device has a USB interface, a USB controller, an interface unit, a device controller and a memory unit.

The USB interface is adapted to be plugged into a USB host to receive a host command outputted from the USB host.

The USB controller is electrically connected with the USB interface and has a sleep mode determination process embedded therein.

The interface unit is electrically connected with the USB controller.

The device controller has a sleep mode.

The memory unit is electrically connected with the device controller for storing data.

The USB controller executes the sleep mode determination process to activate the sleep mode of the device controller through the interface unit and instruct the interface controller and the memory unit to enter a power-down state when predicting that the USB host will not send out any internal device instruction to access the memory unit for a prolonged time.

A second objective of the present invention is to provide a power-saving method of an external power-saving USB mass storage device capable of automatically entering a sleep mode for power-saving purpose.

To achieve the foregoing objective, the external power-saving USB mass storage device has a USB interface, a USB controller, an interface unit, an interface controller and a memory unit, and the power-saving method has steps of:

receiving external host commands;

predicting that data in the memory unit of the external power-saving USB mass storage device will not be read for a prolonged time, and determining a frequency of the external host commands containing internal device instruction;

when the frequency of the received external host commands containing internal device instruction is low, activating the device controller of the external power-saving USB mass storage device to enter a sleep mode so as to instruct the device controller and the memory unit to enter a power down state; and

when the frequency of the received external host commands containing internal device instruction is high, returning to the step of receiving the external host commands.

The sleep mode determination process embedded in the USB controller determines a condition if the received host commands contain any internal device instruction, predicts that the USB host will not access the memory unit for a prolonged time on the basis of the condition, and automatically instructs the device controller and the memory unit to enter a power-down state when intending to access the memory unit to achieve a power-saving effect after a prolonged operation.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of an external power-saving USB mass storage device in accordance with the present invention;

FIG. 2 is a flow diagram of a power-saving method in accordance with the present invention;

FIG. 3 is a flow diagram of a wake-up process embedded in the external power-saving USB mass storage device in FIG. 1;

FIG. 4 is an embodiment of a dormant process of the power-saving method in FIG. 2;

FIG. 5 is another embodiment of a dormant process of the power-saving method in FIG. 2; and

FIG. 6 is a functional block diagram of a conventional external USB mass storage device.

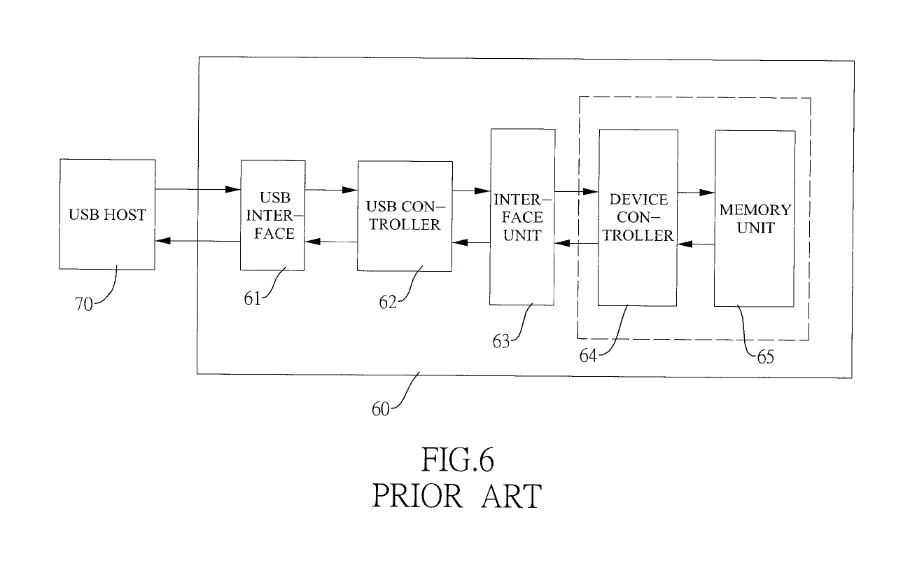

### DETAILED DESCRIPTION OF THE INVENTION

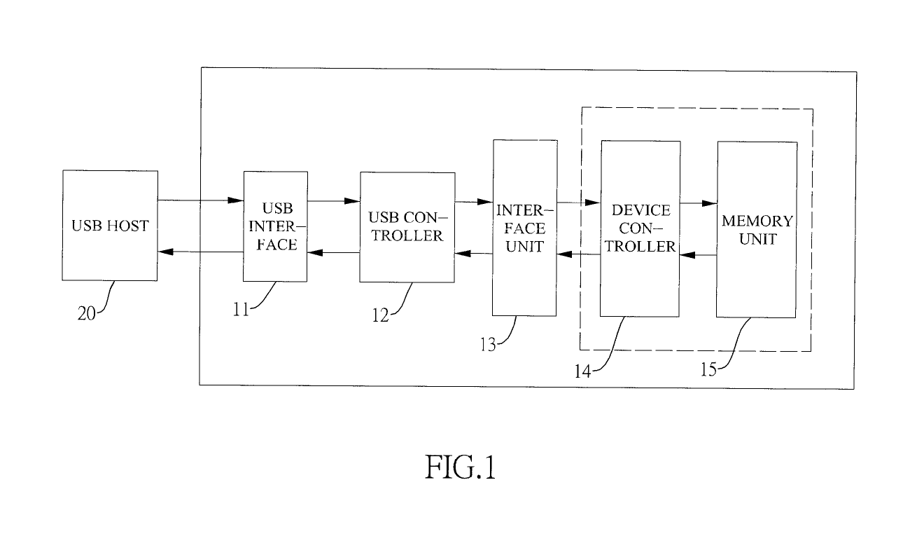

With reference to FIG. 1, an external power-saving USB mass storage device in accordance with the present invention may be a hard disk drive, an optical disk drive and non-volatile memory, is plugged in a USB host 20, and has a USB interface 11, a USB controller 12, an interface unit 13, a device controller 14 and a memory unit 15.

The USB interface 11 is plugged into the USB host 20 to receive a host command outputted from the USB host 20.

The USB controller 12 is electrically connected with the USB interface 11, is electrically connected with the USB host 20 through the USB interface 11, and is embedded with a sleep mode determination process.

The interface unit 13 is electrically connected with the USB controller 12, and may be one of ATA, SATA, ATAPI, SCSI, a memory bus and a memory card bus.

The device controller 14 has a sleep mode.

The memory unit 15 is electrically connected with the device controller 14.

The USB controller executes the sleep mode determination process to activate the sleep mode of the device controller 14 through the interface unit 13, so as to instruct the interface controller 14 and the memory unit 15 to enter a power-down state and also possibly instruct the interface unit 13 to switch to an inactive state for saving power when predicting that the USB host 20 will not access the memory unit 15 for a prolonged time.

The sleep mode determination process determines that the USB host 20 will not access the memory unit 15 for a long period of time based on whether the received host command contains an internal device instruction or not. In the present embodiment, the USB controller 12 has a command counter for counting N consecutive host commands containing no internal device instruction therein. In other words, the command counter serves to indicate that the USB host 20 has not sent out any internal device instruction for data access to the device controller 14 and the memory unit 15 for a while. As a result, the USB controller 12 activates the sleep mode of the device controller 14 to instruct the device controller 14 and the memory unit to enter a power-down state and further instruct the interface unit 13 to enter the inactive state for achieving the effect of hibernation.

In another embodiment, the sleep mode determination process of the USB controller 12 configures a time cycle, and the USB controller 12 has a timer to count the time cycle, and determines if any host command containing an internal device instruction is received within the time cycle. If positive, it indicates that the USB host 20 will not access the memory unit 15 for a long time. The USB controller 12 then activates the device controller 14 to enter the sleep mode, so as to instruct the device controller 14 and the memory unit 15 to enter a power-down state and also possibly further instruct the interface unit 13 to enter the inactive state for achieving the effect of hibernation.

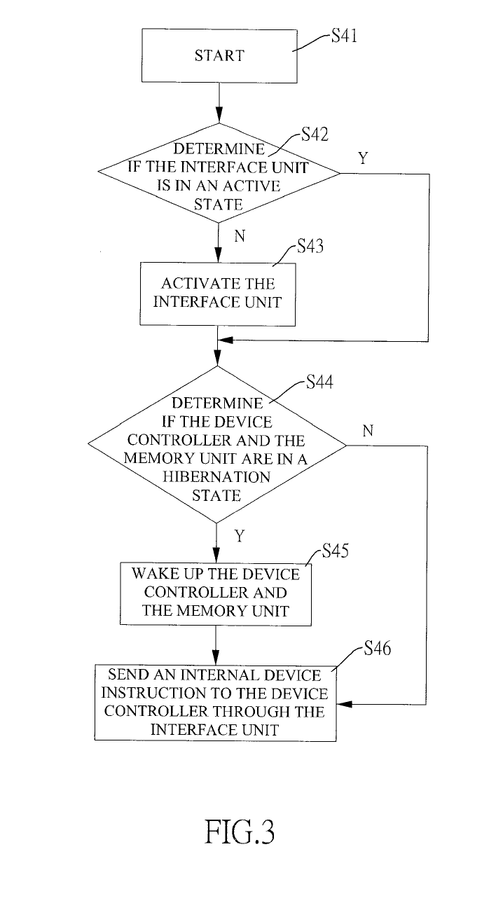

The USB controller 12 of the external USB mass storage device further has a wake-up process embedded in the USB controller 12. Upon receiving the host commands the USB controller 12 executes the wake-up process to enable the device controller 14 and the memory unit 15 in the power-down state to smoothly respond to host commands containing internal device commands therein. With reference to FIG. 3, the wake-up process is executed after determining any external host command contains an internal device instruction, and has the following steps.

Start S41.

Determine if the interface unit 13 is in an active state S42. If negative, activate the interface unit 13 S43, and if positive, perform a next step.

Determine if the device controller 14 and the memory unit 15 are in a hibernation state S44. If positive, wake up the device controller 14 and the memory unit 15 S45, and send an internal device instruction to the device controller 14 through the interface unit 13 S46.

After the USB controller 12 controls the interface unit 13 to enter the inactive state and the device controller 14 and the memory unit 15 to enter the power-down state, the USB controller 12 first instructs the interface unit to return to the active state upon receiving a host command containing an internal device instruction, further wakes up the device controller 14 and the memory unit 15, and instructs the device controller 14 to respond to the internal device instruction. Hence, the USB host 20 can access the hibernated memory unit 15 through the USB controller 12.

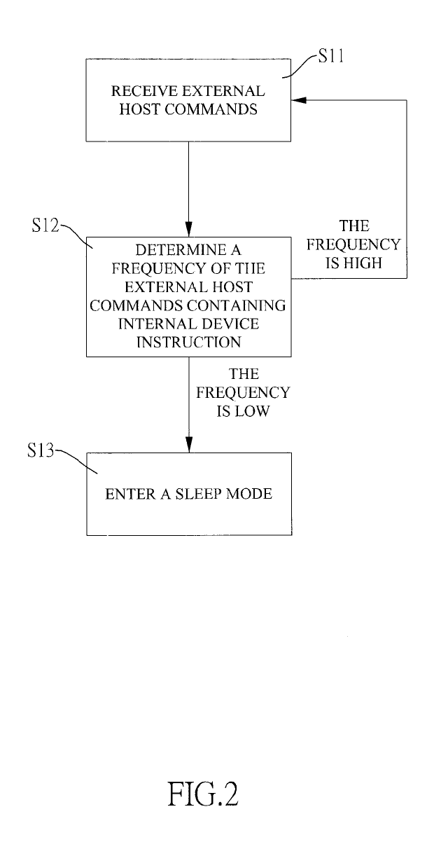

With reference to FIG. 2, a power-saving method of the external USB mass storage device in accordance with the present invention has the following steps.

Receive external host commands S11.

Predict that data in the memory unit 15 of the external USB mass storage device 10 will not be accessed for a long period of time, or, in other words, determine a frequency of the external host commands containing internal device instruction S12.

When the frequency of the received external host commands containing internal device instruction is low, activate the device controller 14 of the USB mass storage device to enter the sleep mode S13 so as to instruct the device controller 14 and the memory unit 15 to enter the power down state.

When the frequency of the received external host commands containing internal device instruction is high, return to Step S11.

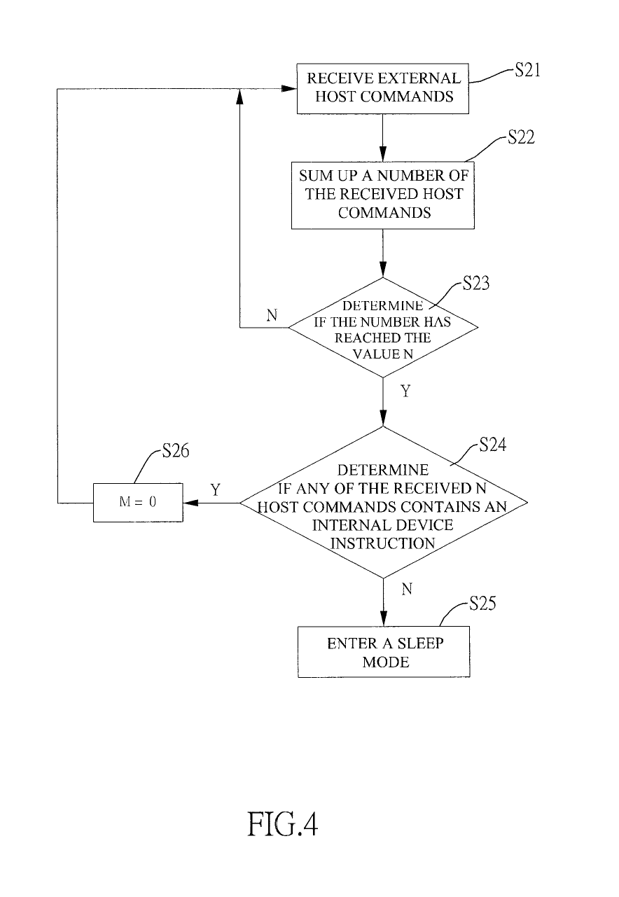

With reference to FIG. 4, an embodiment of the power-saving method of the external USB mass storage device 10 focuses on setting a value N in the above step of determining the frequency of the external host commands containing internal device instruction S12 and has the following steps.

Receive external host commands S21.

Sum up a number of the received host commands S22. Determine if the number has reached the value N S23. If negative, return to Step S21. If positive, execute a next step.

Determine if any of the received. N host commands contains an internal device instruction S24. If positive, initialize the number of the received host commands to zero S26 and return to Step S21. If negative, enter a sleep mode S25.

The present embodiment focuses on predetermining a value N that is used to determine if a number of the received consecutive host commands containing no internal device instructions has reached the value N and determine whether the frequency of the external host commands containing the internal device instructions is high or low. When the N received host commands have no internal device instruction, it represents that the USB host has not sent out any internal device instruction for data access to the device controller 14 and the memory unit 15 for a while or the frequency of the external host commands containing the internal device instructions is low. The USB controller 12 then activates the device controller 14 of the USB mass storage device to enter the sleep mode S13 so as to instruct the device controller 14 and the memory unit 15 to enter the power down state for power-saving purpose.

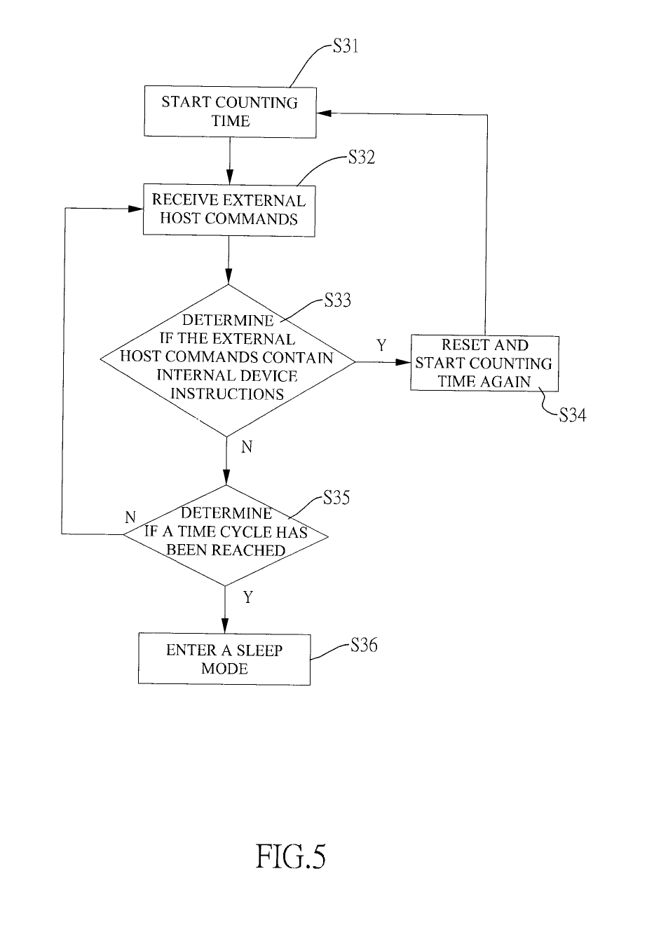

With reference to FIG. 5, another embodiment of the power-saving method of the external USB mass storage device 10 focuses on setting a time cycle in the above step of determining the frequency of the external host commands containing internal device instruction S12 and has the following steps.

Start counting time S31.

Receive external host commands S32.

Determine if the external host commands contain internal device instructions. If positive, reset and start counting time again and return to Step S31 S34. If negative, execute a next step.

Determine if a time cycle has been reached S35. If positive, enter a sleep mode S36. If negative, return to Step S32.

It is noted that the present embodiment predetermines a time cycle and determines a condition of host commands containing internal device instructions received in a single time cycle, which serves as a frequency of host commands containing internal device instructions. If no single host command containing internal device instruction is received at all in the time cycle, it represents that the USB host will not access data in the memory unit for a long time. The USB controller 12 then activates the device controller 14 of the USB mass storage device to enter the sleep mode S13 so as to instruct the device controller 14 and the memory unit 15 to enter the power down state for power-saving purpose.

In sum, the sleep mode determination process embedded in the USB controller of the present invention predicts that the USB host will not access the memory unit for a long while, further instructs the device controller and the memory unit to enter the power-down state, and wakes up the device controller and the memory unit when intending to access the memory unit. Accordingly, a power-saving effect can be achieved after a prolonged operation.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An external power-saving USB mass storage device, comprising:
a USB interface adapted to be plugged into a USB host to receive a host command outputted from the USB host;
a USB controller electrically connected with the USB interface and having a sleep mode determination process embedded therein;
an interface unit electrically connected with the USB controller;
a device controller having a sleep mode; and
a memory unit electrically connected with the device controller for storing data;
wherein the USB controller executes the sleep mode determination process to activate the sleep mode of the device controller through the interface unit and instruct the interface controller and the memory unit to enter a power-down state when predicting that the USB host will not send out any internal device instruction to access the memory unit for a prolonged time.

2. The external power-saving USB mass storage device as claimed in claim 1, wherein the USB controller has a command counter and activates the sleep mode of the device controller so as to instruct the device controller and the memory unit to enter the power-down state after determining that N consecutive host commands counted by the command counter contain no internal device instruction.

3. The external power-saving USB mass storage device as claimed in claim 1, wherein the USB controller configures a time cycle, has a timer for counting the time cycle, and determines if any host command containing an internal device instruction is received within the time cycle, if positive, the USB controller activates the device controller to enter the sleep mode so as to instruct the device controller and the memory unit to enter the power-down state.

4. The external power-saving USB mass storage device as claimed in claim 2, wherein after the device controller and the memory unit are in the power-down state, the USB controller instructs the interface unit to enter an inactive state.

5. The external power-saving USB mass storage device as claimed in claim 4, wherein the USB controller further has a wake-up process embedded therein and executes the wake-up process when receiving a host command having an internal device instruction, and the wake-up process has steps of:
starting;
determining if the interface unit is in an active state, if negative, activating the interface unit, and if positive, performing a next step; and
determining if the device controller and the memory unit are in a hibernation state, and if positive, waking up the device controller and the memory unit and sending the internal device instruction to the device controller through the interface unit.

6. The external power-saving USB mass storage device as claimed in claim 1, wherein the interface unit is one of ATA, SATA, ATAPI, SCSI, memory bus and memory card bus.

7. The external power-saving USB mass storage device as claimed in claim 2, wherein the interface unit is one of ATA, SATA, ATAPI, SCSI, memory bus and memory card bus.

8. The external power-saving USB mass storage device as claimed in claim 3, wherein the interface unit is one of ATA, SATA, ATAPI, SCSI, memory bus and memory card bus.

9. The external power-saving USB mass storage device as claimed in claim 5, wherein the interface unit is one of ATA, SATA, ATAPI, SCSI, memory bus and memory card bus.

10. A power-saving method of an external power-saving USB mass storage device, wherein the external power-saving USB mass storage device has a USB interface, a USB controller, an interface unit, an interface controller and a memory unit; the power-saving method comprising steps of:
receiving external host commands;
predicting that data in the memory unit of the external power-saving USB mass storage device will not be read for a prolonged time, and determining a frequency of the external host commands containing internal device instruction;
when the frequency of the received external host commands containing internal device instruction is low, activating the device controller of the external power-saving USB mass storage device to enter a sleep mode so as to instruct the device controller and the memory unit to enter a power down state; and
when the frequency of the received external host commands containing internal device instruction is high, returning to the step of receiving the external host commands.

11. The external power-saving USB mass storage device as claimed in claim 10, wherein
a value N is set in the step of determining a frequency of the external host commands containing internal device instruction,
a condition when a number of the received host commands has reached the value N and the N consecutive host commands contain no internal device instruction indicates a high frequency of the received host commands, and
when N consecutive host commands contain no internal device instruction, the device controller of the external power-saving USB mass storage device is activated to enter the sleep mode so as to instruct the device controller and the memory unit to enter the power down state.

12. The external power-saving USB mass storage device as claimed in claim 9, wherein a time cycle is set in the step of determining a frequency of the external host commands containing internal device instruction, and when no host command containing internal device instruction is received in the time cycle, the device controller is activated to enter the sleep mode so as to instruct the device controller and the memory unit to enter the power-down state.
